(19) United States
(12) Patent Application Publication
(10) Pub. No.: US 2017/0059142 A1
(43) Pub. Date: Mar. 2, 2017

(54) LED LIGHT FIXTURES

(71) Applicant: SHANGHAI YUANMING LIGHTING TECHNOLOGY CO., LTD., Shanghai (CN)

(72) Inventor: Jishuang YE, Shanghai (CN)

(73) Assignee: SHANGHAI YUANMING LIGHTING TECHNOLOGY CO., LTD., Shanghai (CN)

(21) Appl. No.: 14/879,698

(22) Filed: Oct. 9, 2015

(30) Foreign Application Priority Data
Aug. 31, 2015 (CN) 2015 1054 6176.1

(51) Int. Cl. F21V 23/02; F21V 31/00; F21V 23/00; H05B 37/02; H05B 33/08

(52) U.S. Cl. CPC F21V 23/02; H05B 37/0272; H05B 33/0845; H05B 37/0263; F21V 23/002; F21V 31/00

(57) ABSTRACT

A LED light fixture, including an internally installed power supply, wherein an outlet is defined in a housing of the light fixture and a cable is inserted through the outlet, the cable having one end passing through the outlet and the other end in connection with the power supply, the cable comprising input wires for the power supply and communication wires, the communication wires serving as programming and setting lines for the power supply and being configured to set output electrical parameters of the power supply. When to reset the output electrical parameters of the LED light fixture, a handheld controller may be coupled to the communication lines of the power supply to fulfill the task, without needing to open the housing of the LED light fixture and removing a waterproof plug arranged on the power supply.

### TECHNICAL FIELD OF THE INVENTION

The present invention relates to the field of lighting fixtures and, in particular, to light-emitting diode (LED) lighting fixture.

### BACKGROUND OF THE INVENTION

As the currently most popular illumination light sources, LEDs are finding increasingly extensive applications. In accordance with operating characteristics of LED semiconductor materials, LEDs usually use power supplies with constant current outputs, in order to ensure their high performance reliability and to facilitate their control. When a LED serving as a light source is provided with an increase in operating current by a power supply, a luminous flux generated by the LED will be increased, and vice versa. In other words, light-dimming can be effectuated by adjusting the LED's forward conduction current.

In practice, when a user purchases a number of LED power supplies, it is possible that LED panels of different types, i.e., for serial or parallel connection of different numbers of LEDs, are used therewith. However, for LEDs of a certain type, the use of LED panels allowing serial or parallel connection of different numbers of the LEDs requires different operating voltages and operating currents. In order to solve this problem, the user needs to reset output parameters of the power supplies. Otherwise, he has to purchase power supplies of a variety of types having different output characteristics to meet the aforesaid requirement. On the other hand, in order to meet the customer's requirement for rapid delivery, the manufacturer of the power supplies needs to keep a variety of power supplies having different specifications in stock. This leads to increases both in the user's purchase cost and in the manufacturer's management cost.

FIG. 1 shows a conventional programmable LED power supply, which has three input wires on the left, including a neutral wire, a live wire and a ground wire, and output wires on the right. In normal operation, it outputs a constant voltage and a constant current. When to make adjustments in the output voltage or current, retaining screws fixed in a bottom plate of a LED light fixture on which the power supply is mounted must be loosened firstly to allow removal of a housing of the fixture. After that, a waterproof plug or cap that is accessible from an outer casing of the power supply is further removed, followed by coupling an input power supply, as well as a load and a wattmeter. Parameters are then adjusted according to readings of the wattmeter, with the power supply being in an operating state in order to enable determining whether the parameter adjustments are reasonable. This task is very cumbersome and usually needs to be fulfilled by professionals, thus entailing great labor costs in applications where a great number of LED light fixtures are used. In addition, it is difficult for conventional LED light fixtures to be configured to work with different parameter sets in different time frames.

Therefore, there exists a need for a novel LED light fixture which allows simple parameter settings for ready adaptability to installation requirements in various occasions.

### BRIEF INTRODUCTION OF THE INVENTION

It is therefore an object of the present invention to overcome the problem of inconvenient adjustments of electrical parameters arising from the use of the conventional LED light fixtures by presenting a novel LED light fixture allowing convenient tuning of its electrical parameters.

In pursuit of this object, the LED light fixture according to the present invention including a power supply installed internally, wherein an outlet is defined in a housing of the light fixture and a cable is inserted through the outlet, the cable having one end passing through the outlet and the other end in connection with the power supply, the cable comprising input wires for the power supply and communication wires, the communication wires serving as programming and setting lines for the power supply and being configured to set output electrical parameters of the power supply.

According to embodiments of the present invention, the communication wires can also serve as dimming lines for the LED light fixture.

According to embodiments of the present invention, the communication wires can be further coupled to a data relay module that is configured to wirelessly communicate with a communication device capable of wireless communication.

Further, the wireless communication can be implemented as any of Bluetooth, ZigBee, Wi-Fi and Infrared communications, with the communication device being implemented as any of a cellular phone, a controller and a computer.

As an alternative solution, a LED light fixture including a power supply installed internally, wherein two outlets are defined in a housing of the light fixture and two cables are inserted through the respective outlets, each of the two cables having one end passing through the outlet and the other end in connection with the power supply, one of the two cables acting as an input cable for the power supply and the other as an communication cable, the communication cable serving as a programming and setting line for the power supply and being configured to set output electrical parameters of the power supply.

According to embodiments of the present invention, the communication cable can also serve as a dimming line for the LED light fixture.

According to embodiments of the present invention, the communication cable can be further coupled to a data relay module that is configured to wirelessly communicate with a communication device capable of wireless communication.

Further, the wireless communication can be implemented as any of Bluetooth, ZigBee, Wi-Fi and Infrared communications, with the communication device being implemented as any of a cellular phone, a controller and a computer.

As another alternative solution, a LED light fixture including a power supply installed internally, wherein the light fixture is provided with an interface having an inner side in connection to the power supply via a cable that acts as a communication cable, the communication cable serving as a programming and setting line for the power supply and being configured to set output electrical parameters of the power supply.

According to embodiments of the present invention, the communication cable can also serve as a dimming line for the LED light fixture.

As a further alternative solution, a LED light fixture including a power supply installed internally, wherein a wireless signal receiver is disposed inside a housing of the light fixture, the wireless signal receiver being in connection with the power supply via a cable that acts as a communication cable, the communication cable serving as a programming and setting line for the power supply and being configured to set output electrical parameters of the power supply.

According to embodiments of the present invention, the communication cable can also serve as a dimming line for the LED light fixture.

According to embodiments of the present invention, the wireless signal receiver can communicate with a wireless communication device in a wireless manner and set output electrical parameters of the LED light fixture by receiving signals from the wireless communication device.

Further, the wireless communication can be implemented as any of Bluetooth, ZigBee, Wi-Fi and Infrared communications, with the communication device being implemented as any of a cellular phone, a controller and a computer.

As a further alternative solution, a LED light fixture including a power supply installed internally, the power supply has an input cable leading out of the light fixture through an outlet, wherein a power line carrier communication unit is disposed inside the LED light fixture, the power line carrier communication unit being in connection with the input cable of the power supply, the power line carrier communication unit and the input cable of the power supply being configured together to allow settings of output electrical parameters of the power supply.

Settings/re-settings of output electrical parameters of the LED light fixtures according to the present invention can be realized by a control means, such as a controller or a computer, coupled to communication lines in connection with the power supply, or by a wireless communication device, along with a wireless signal receiver arranged in the LED light fixture, without needing operations, such as opening the housing of the light fixture or removing a waterproof plug from the power supply, furthermore, the operation can be implemented in a non-operating state of the power supply. This imparts simplicity and practicality to the LED light fixtures.

### BRIEF DESCRIPTION OF THE DRAWINGS

FIG. 1 illustrates a schematic illustration of a programmable LED power supply in the art.

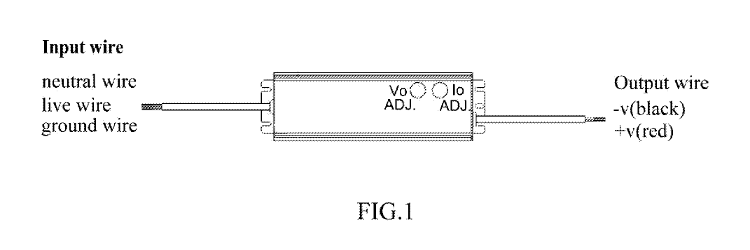

FIG. 2 illustrates a LED light fixture according to a first example of the present invention.

FIG. 3 illustrates a handheld controller for use to set electrical parameters of the LED light fixture according to the first example of the present invention.

FIG. 4 illustrates a LED light fixture according to a second example of the present invention.

FIG. 5 illustrates a data relay module and a wireless communication device both for use in electrical parameter settings of the LED light fixture according to the second example of the present invention.

FIG. 6 illustrates a LED light fixture according to a third example of the present invention.

FIG. 7 illustrates a computer for use in electrical parameter settings of the LED light fixture according to the third example of the present invention.

FIG. 8 illustrates a LED light fixture according to a fourth example of the present invention.

FIG. 9 illustrates the LED light fixture according to the fourth example of the present invention in an assembled state.

FIG. 10 illustrates a LED light fixture according to a fifth example of the present invention.

FIG. 11 illustrates an operating routine for the LED light fixture according to the second application example of the present invention.

### DETAILED DESCRIPTION OF THE INVENTION

In order for a better understanding of the present invention, several embodiments are set forth below to describe the invention in greater detail without limiting the scope thereof in any sense.

### Example 1

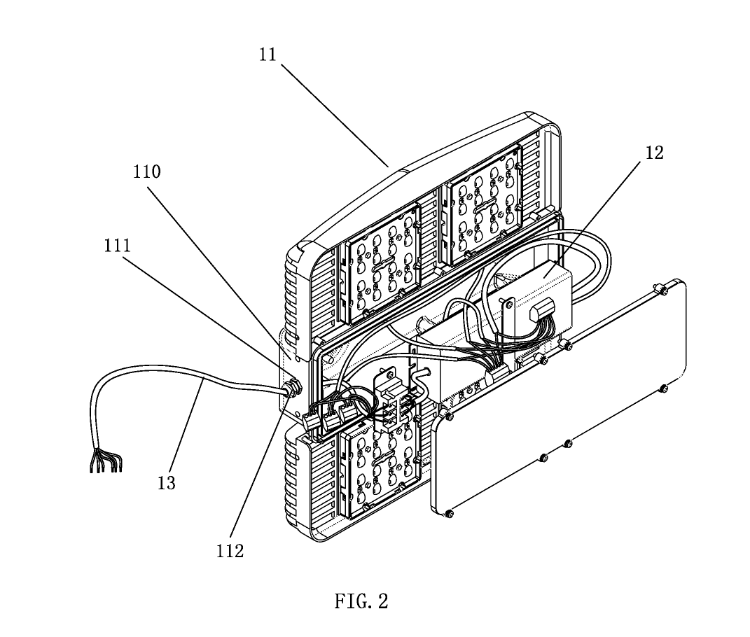

FIG. 2 shows a LED light fixture according to a first example of the present invention. A programmable power supply 12 is disposed inside the LED light fixture 11 which has a housing 110 defining an outlet 111. A cable 13 is inserted through the outlet 111, and a watertight joint 112 is disposed at the outlet 111 for providing waterproofness there. One end of the cable 13 extends out of the housing 110 of the light fixture, and the other end thereof is in connection with the power supply 12. The cable 13 includes at least five wires, three of which act as input wires, i.e., a null wire, a live wire and a ground wire, of the power supply 12, and the remaining two of which act as communication wires of the LED light fixture 11. The communication wires serve as programming and setting lines for the power supply 12 and are configured to set output electrical parameters of the power supply 12. In this example, the two communication lines also function as dimming lines for the LED light fixture 11.

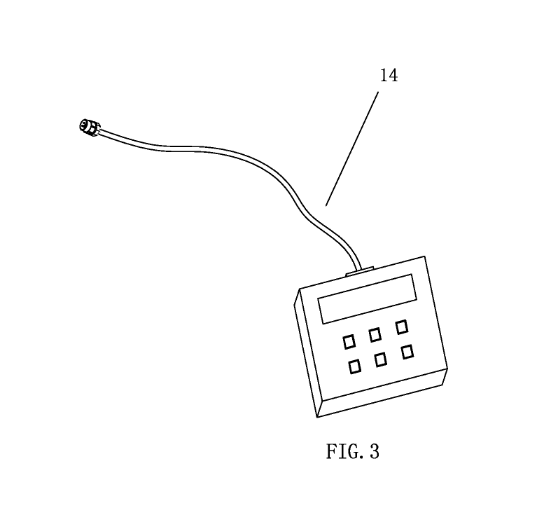

When to reset the output electrical parameters of the LED light fixture, a handheld controller 14, as shown in FIG. 3, may be coupled to the communication lines of the power supply 12 to fulfill the task, without needing to open the housing 111 of the LED light fixture 11 or removing a waterproof plug arranged on the power supply 12. In addition, this process is allowed to be carried out in a non-operating state of the power supply 12 and is thus simple and convenient.

### Example 2

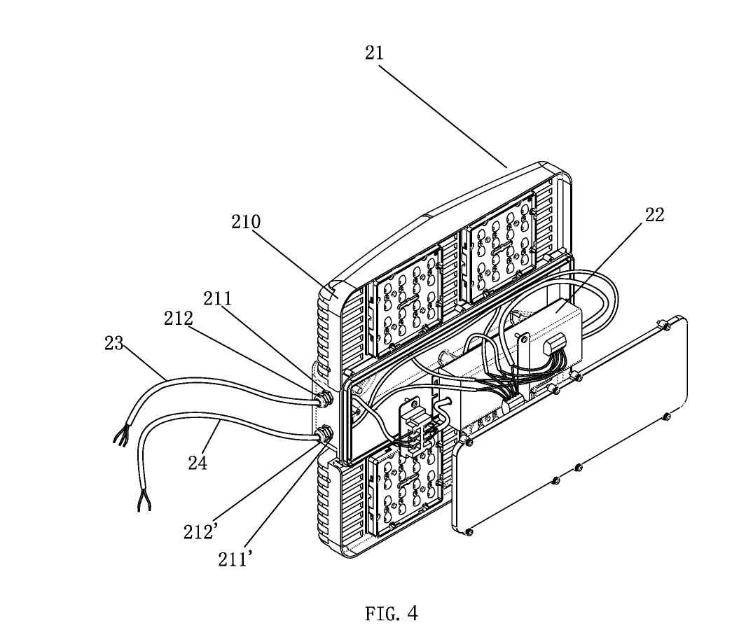

FIG. 4 shows a LED light fixture according to a second example of the present invention. A power supply 22 is disposed inside the LED light fixture 21 which has a housing 210 defining two outlets 211, 211′. Two cables 23, 24 are inserted through the outlets 211, 211′ respectively, and watertight joints 212, 212′ are disposed at the outlets 211, 211′ respectively for providing waterproofness there. Each of the cables 23, 24 has one end disposed out of the housing 210 of the light fixture and the other end in connection with the power supply 22. The cable 23 serves as an input cable for the power supply 22 and includes three wires, i.e., a null wire, a live wire and a ground wire. The cable 24 includes at least two wires (optionally an auxiliary power wire as well) which are implemented as communication wires, serving as programming and setting lines for the power supply 22 and configured to set output electrical parameters thereof. In addition, the communication wires also serve as dimming lines for the LED light fixture.

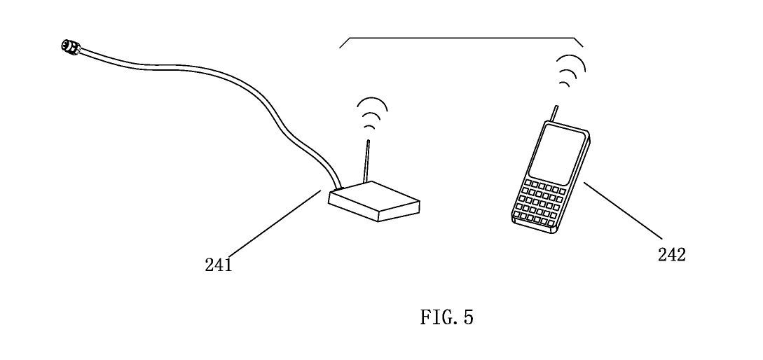

When to reset the output electrical parameters of the LED light fixture, the communication cable 24 may be coupled to a data relay module 241, as shown in FIG. 5, which may in turn wirelessly communicate with a communication device 242 capable of wireless communication. The wireless communication may be implemented as any of Bluetooth, ZigBee, Wi-Fi and Infrared communications, and the communication device 242 may be implemented as any of a cellular phone, a controller and a computer. With the aid of the data relay module 241 and the communication device 242, settings of the output electrical parameters of the LED light fixture are simply achievable.

As a matter of course, it is easily understandable to those skilled in the art that it is also possible for this example to employ the handheld controller as described above in conjunction with Example 1 to perform the programming and setting functions.

### Example 3

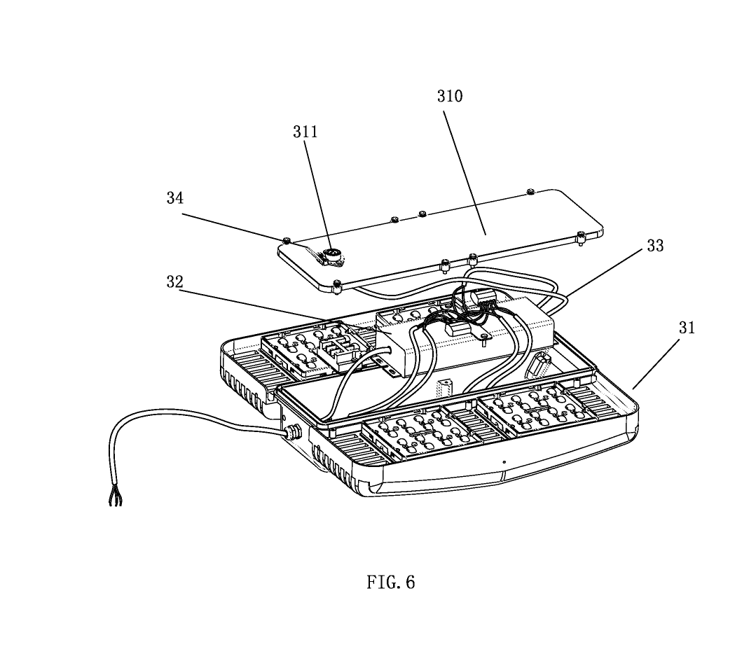

FIG. 6 shows a LED light fixture according to a third example of the present invention. A power supply 32 is disposed inside the LED light fixture 31 which is provided with an interface 311. An inner side of the interface 311 is coupled to the power supply 32 via a cable 33 which includes at least two wires implemented as communication wires that serve as programming and setting lines for the power supply 32 and are configured to set output electrical parameters thereof. In addition, the communication wires also serve as dimming lines for the LED light fixture 31.

In this example, in order to prevent dust and water, a cover plate 34 may be disposed over the interface 311.

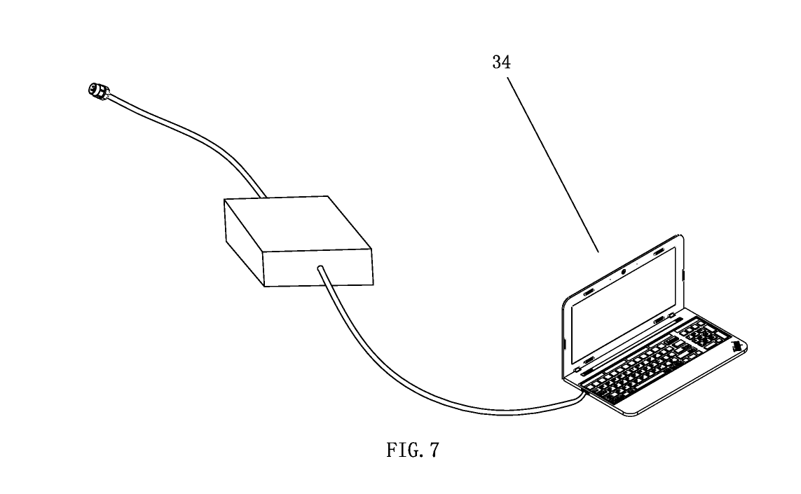

When to reset the output electrical parameters of the LED light fixture 31, a handheld controller 14 (FIG. 3) or a computer (FIG. 7) may be coupled to the interface 311, thereby allowing fulfilling the task in a simple and rapid manner.

### Example 4

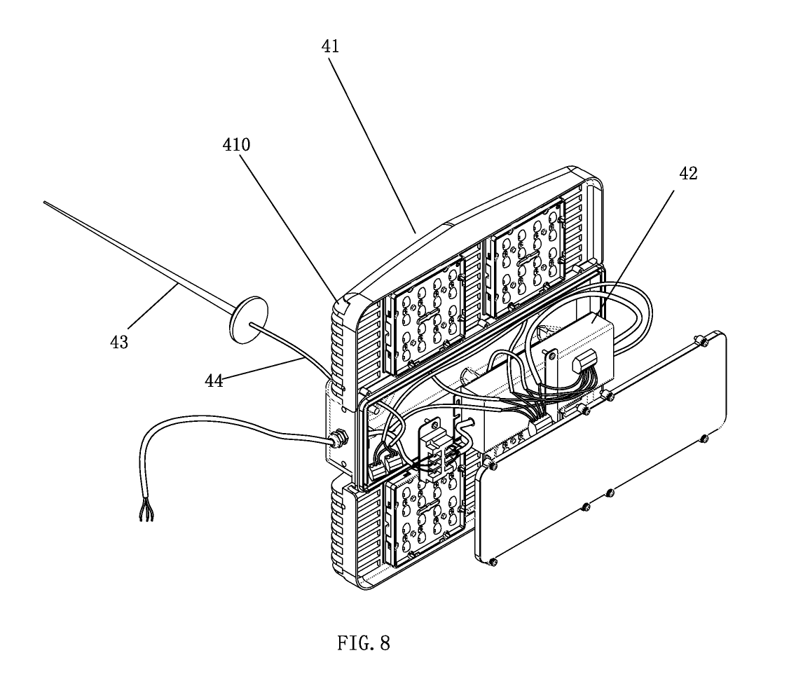

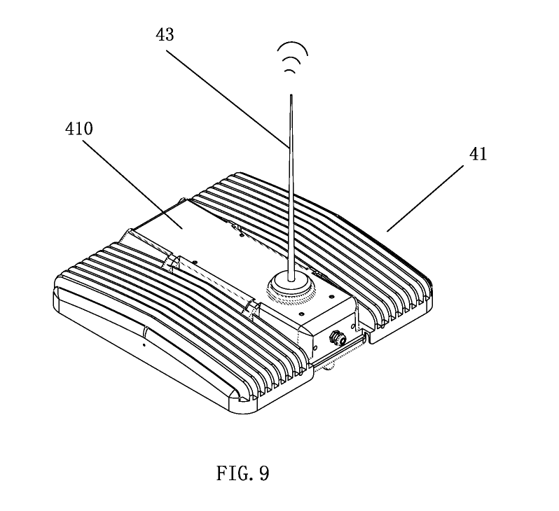

FIGS. 8 and 9 show a LED light fixture according to a fourth example of the present invention. A power supply 42 is disposed inside the LED light fixture 41 having a housing 410 on which a wireless signal receiver 43 is arranged. The wireless signal receiver 43 is in connection with the power supply 42 via a cable 44 which includes at least two wires implemented as communication wires that serve as programming and setting lines for the power supply 42 and are configured to set output electrical parameters thereof. In addition, the communication wires also serve as dimming lines for the LED light fixture 41.

In this example, the wireless signal receiver 43 may communicate with, for example, the wireless communication device 242 of FIG. 5 in a wireless manner. The wireless communication device 242, together with the wireless signal receiver 43, enables output electrical parameter settings of the LED light fixture 41. The wireless communication may be implemented as any of Bluetooth, ZigBee, Wi-Fi and Infrared communications, and the communication device 242 may be implemented as any of a cellular phone, a controller and a computer.

In this example, the wireless signal receiver 43 is desirably implemented as an antenna for receiving signals. It is easily understandable to those skilled in the art that the antenna may be an embedded device, i.e., received wholly inside the housing 410 and thus invisible from the outside. In case of infrared communication, it is impossible for the wireless signal receiver to be completely embedded, and a component thereof for receiving infrared signals needs to be arranged on the housing 410 (e.g., on a bottom plate) of the light fixture in an exposed manner.

### Example 5

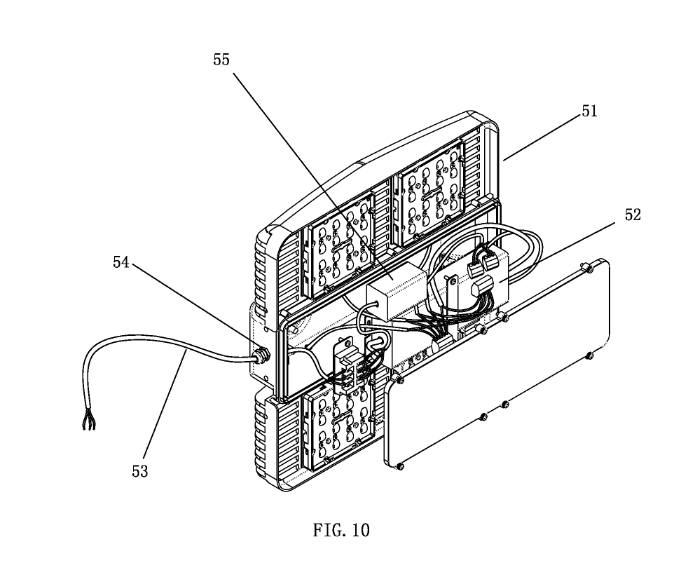

FIG. 10 shows a LED light fixture according to a fifth example of the present invention. A power supply 52 is disposed inside the LED light fixture 51 and has an input cable 53 leading out of the fixture through an outlet 54. A power line carrier communication unit 55 is disposed inside the LED light fixture and is in connection with the input cable 53 of the power supply 52. The power line carrier communication unit 55, together with the input cable 53, enables output electrical parameter settings of the power supply 52.

In these embodiments, the output electrical parameters of the LED light fixtures are set by programming and setting circuits of the power supplies, including output voltages, output currents, maximum output powers, time frames and dimming rates of a time-dependent dimming mode, and activation/deactivation of a temperature protection function (i.e., automated output current reduction in response to the power supply's internal temperature going beyond a preset limit).

### Application Example 1

A suitable programmable LED power supply was manufactured with a factory default maximum output power of 200 W. After it was mounted on a LED light fixture according to the present invention, a user could perform dimming of the light fixture through exposed communication wires, with a general power of the light fixture varying accordingly in the range of from 20 W to 200 W. However, a new project of the user required to use a 120 W power supply in a street in Shanghai, thus necessitating resetting the maximum operating parameter of the power supply in the light fixture. To this end, a device for enabling electrical parameter setting was connected to terminals of the communication wires, and the electrical parameter of the power supply was modified thereby. As a result, the maximum output power of the power supply was adjusted to 120 W. After the light fixture was installed in the field, its power varies in the range of 12-120 W upon the user performing dimming by means of the communication wires. Thanks to the use of the fixture of the present invention, the electrical parameter modification of the LED light fixture was achieved without needing to detach the power supply throughout the whole process.

### Application Example 2

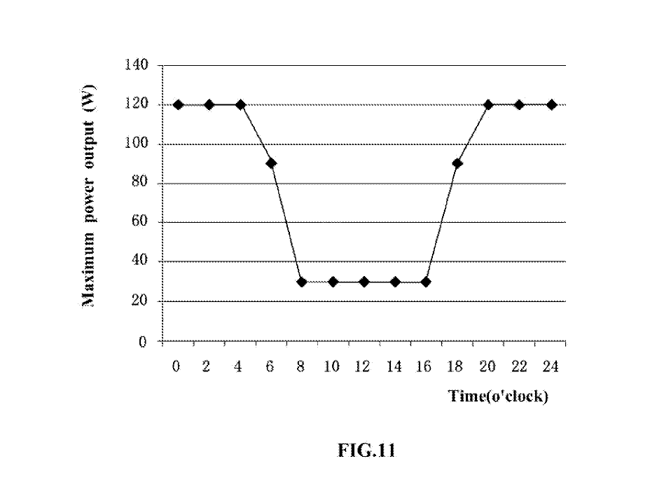

A suitable programmable LED power supply was manufactured with a factory default maximum output power of 200 W. After it was deployed to a street in Shanghai, it operated with an electrical parameter varying in several times frames, as shown in FIG. 11. To this end, a device for enabling the setting of output electrical parameters of a LED light fixture was connected to terminals of communication wires of the LED light fixture, and an operating routine as shown in FIG. 11 was input beforehand in the device. Specifically, the routine included the following steps:

maintaining a maximum output power at 120 W in the time frame from 0 o'clock to 4 o'clock;

decreasing the maximum output power from 120 W to 30 W in the time frame from 4 o'clock to 8 o'clock;

maintaining the maximum output power at 30 W in the time frame from 8 o'clock to 16 o'clock;

increasing the maximum output power from 30 W to 120 W in the time frame from 16 o'clock to 20 o'clock;

maintaining the maximum output power at 120 W in the time frame from 20 o'clock to 4 o'clock next day; and

repeating the preceding steps.

After the power supply was mounted on the light fixture, directly inputting the operating routine shown in FIG. 11 in the power supply in the LED light fixture could make the LED light fixture operate in accordance with the input operating routine.

While detailed description of specific embodiments of the present invention has been presented above about, these embodiments are merely exemplary and the invention is not limited to the disclosed embodiments. It is to be understood by those skilled in the art that all equivalent modifications and substitutions made to the present invention also fall within the scope of the invention. Therefore, all equivalent variations and modifications made without departing from the spirit and scope of the present invention are considered to be within the scope thereof.

What is claimed is:

1. A light-emitting diode (LED) light fixture, including a power supply installed internally, wherein an outlet is defined in a housing of the light fixture and a cable is inserted through the outlet, the cable having one end passing through the outlet and the other end in connection with the power supply, the cable comprising input wires for the power supply and communication wires, the communication wires serving as programming and setting lines for the power supply and being configured to set output electrical parameters of the power supply.

2. The LED light fixture according to claim 1, wherein the communication wires also serve as dimming lines for the LED light fixture.

3. The LED light fixture according to claim 1, wherein the communication wires are further coupled to a data relay module that is configured to wirelessly communicate with a communication device capable of wireless communication.

4. The LED light fixture according to claim 3, wherein the wireless communication is implemented as any of Bluetooth, ZigBee, Wi-Fi and Infrared communications, and wherein the communication device is implemented as any of a cellular phone, a controller and a computer.

5. A light-emitting diode (LED) light fixture, including a power supply installed internally, wherein two outlets are defined in a housing of the light fixture and two cables are inserted through the respective outlets, each of the two cables having one end passing through the outlet and the other end in connection with the power supply, one of the two cables acting as an input cable for the power supply and the other as an communication cable, the communication cable serving as a programming and setting line for the power supply and being configured to set output electrical parameters of the power supply.

6. The LED light fixture according to claim 5, wherein the communication cable also serves as a dimming line for the LED light fixture.

7. The LED light fixture according to claim 5, wherein the communication cable is further coupled to a data relay module that is configured to wirelessly communicate with a communication device capable of wireless communication.

8. The LED light fixture according to claim 7, wherein the wireless communication is implemented as any of Bluetooth, ZigBee, Wi-Fi and Infrared communications, and wherein the communication device is implemented as any of a cellular phone, a controller and a computer.

9. A light-emitting diode (LED) light fixture, including a power supply installed internally, wherein the light fixture is provided with an interface having an inner side in connection to the power supply via a cable that acts as a communication cable, the communication cable serving as a programming and setting line for the power supply and being configured to set output electrical parameters of the power supply.

10. The LED light fixture according to claim 9, wherein the communication cable also serves as a dimming line for the LED light fixture.

11. A light-emitting diode (LED) light fixture, including a power supply installed internally, wherein a wireless signal receiver is disposed inside a housing of the light fixture, the wireless signal receiver being in connection with the power supply via a cable that acts as a communication cable, the communication cable serving as a programming and setting line for the power supply and being configured to set output electrical parameters of the power supply.

12. The LED light fixture according to claim 11, wherein the communication cable also serves as a dimming line for the LED light fixture.

13. The LED light fixture according to claim 11, wherein the wireless signal receiver communicates with a wireless communication device in a wireless manner and sets output electrical parameters of the LED light fixture by receiving signals from the wireless communication device.

14. The LED light fixture according to claim 13, wherein the wireless communication is implemented as any of Bluetooth, ZigBee, Wi-Fi and Infrared communications, and wherein the communication device is implemented as any of a cellular phone, a controller and a computer.

15. A light-emitting diode (LED) light fixture, including a power supply installed internally, the power supply having an input cable leading out of the light fixture through an outlet, wherein a power line carrier communication unit is disposed inside the LED light fixture and is in connection with the input cable of the power supply, the power line carrier communication unit and the input cable of the power supply being configured together to allow the setting of output electrical parameters of the power supply.
